(19) United States
(12) Patent Application Publication
(10) Pub. No.: US 2004/0182197 A1
(43) Pub. Date: Sep. 23, 2004

(54) Bicycle crank

(76) Inventor: Cheng-Hsun Chiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/389,937

(22) Filed: Mar. 18, 2003

(51) Int. Cl. G05G 1/14

(52) U.S. Cl. 74/594.1

(57) ABSTRACT

A bicycle crank includes a first connection portion with a first outer threaded portion and a second connection portion with a second outer threaded portion. A core portion made of carbon-fiber is connected between the first connection and the second connection portion. The first outer threaded portion and the second outer threaded portion are partially embraced by the core portion. An outer layer made of carbon-fiber is coated to the first connection portion, the second connection portion and the core portion.

### FIELD OF THE INVENTION

The present invention relates to a bicycle crank that includes two connection portions connected with a core portion and a carbon-fiber layer is coated to the two connection portions and the core portion.

### BACKGROUND OF THE INVENTION

A conventional bicycle crank generally includes a body with two connection portions on two ends of the body. The body and the two connection portions are made of metal material. Although a better structural strength can be expected by the metal, nevertheless, the weight is not satisfied and which is a trend of the bicycle design. Even if an improved bicycle crank is developed by using carbon-fiber, the two connection portions are still made of metal such as Aluminum. The two connection portions are made by Aluminum and each include at least one extension which are used to be connected with carbon-fiber. The at least one extension on each of the connection portions increases complexity of the molds for making the connection portions and the Aluminum is still too weight when compared with that of carbon-fiber.

The present invention intends to provide a bicycle crank that has two connection portions connected by a carbon-fiber core portion and an outer carbon-fiber layer is coated to the combination of the two connection portions and the carbon-fiber core portion.

### SUMMARY OF THE INVENTION

In accordance with one aspect of the present invention, there is provided a bicycle crank which comprises a first connection portion having a first outer threaded portion, and a second connection portion having a second outer threaded portion. A core portion made of carbon-fiber is connected between the first connection and the second connection portion. The first outer threaded portion and the second outer threaded portion are partially embraced by the core portion. An outer layer made of carbon-fiber is coated to the first connection portion, the second connection portion and the core portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view, partly removed, of the bicycle crank of the present invention;

FIG. 2 is a cross section to show the two connection members with a core portion connected therebetween;

FIG. 3 is a cross section to show the bicycle crank of the present invention;

FIG. 4 is a perspective view to show the crank as illustrated in FIG. 2, and

FIG. 5 shows an outer layer is coated to the crank as illustrated in FIG. 4.

### DETAILED DESCRIPTION OF THE PREFERRED EMBODIMENT

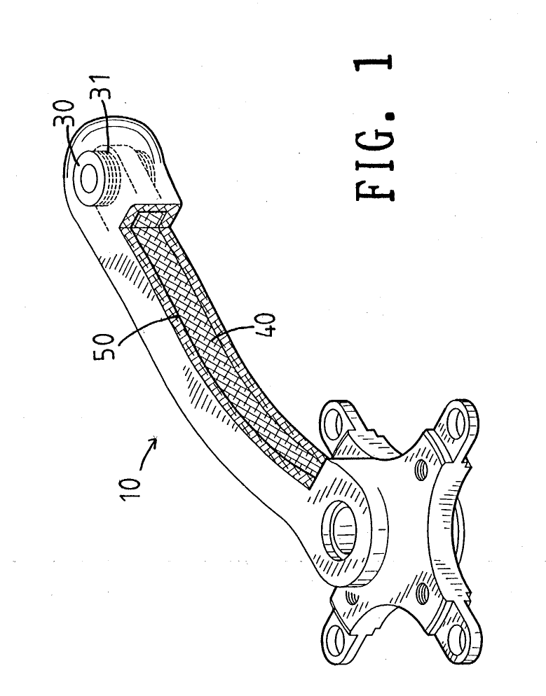

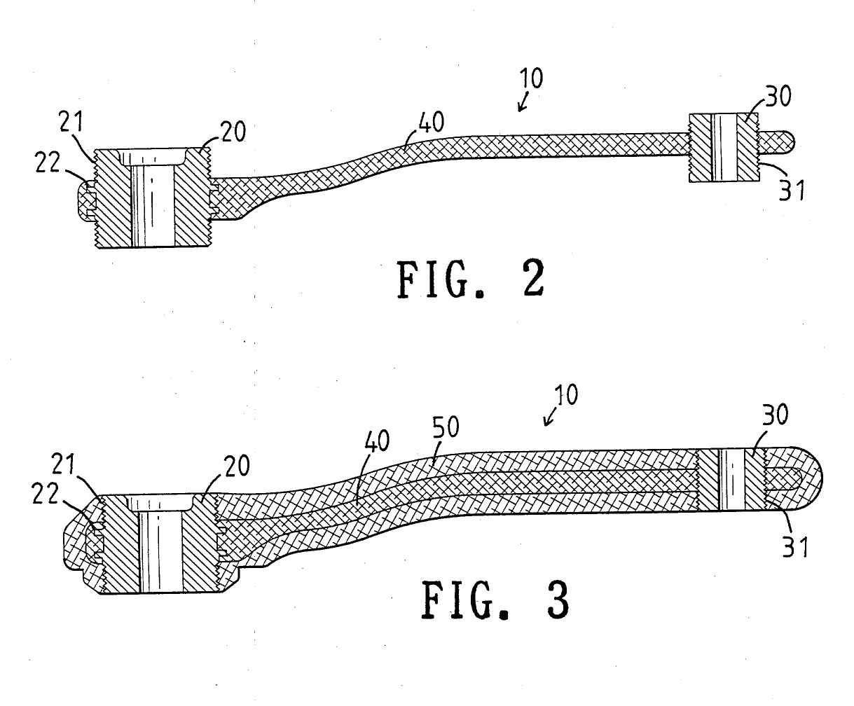

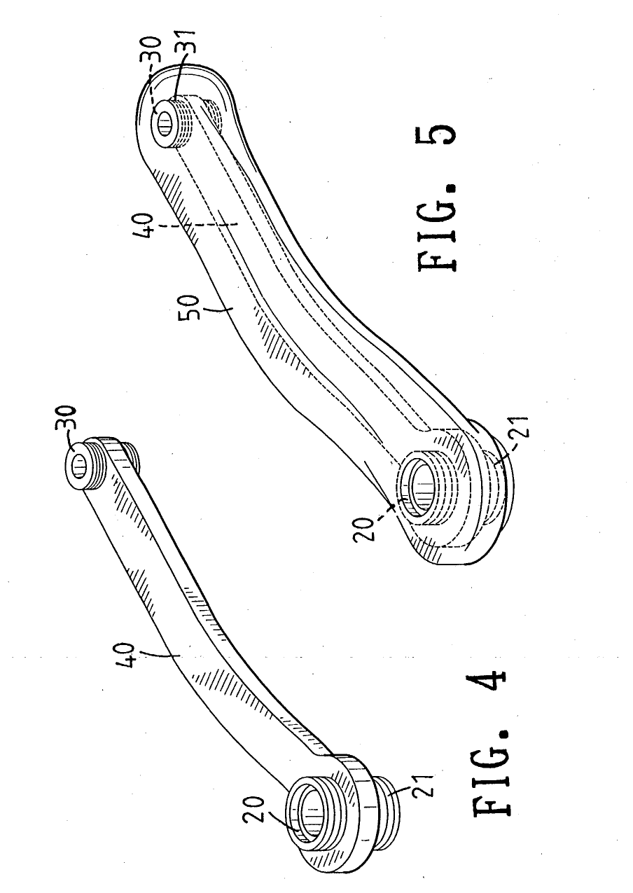

Referring to FIGS. 1, 2 and 4, the bicycle crank 10 of the present invention comprises a first connection portion 20 having a first outer threaded portion 21 and flanges 22 extend radially from an outer periphery of the first connection portion 20. A second connection portion 30 has a second outer threaded portion 31.

A core portion 40 made of carbon-fiber is connected between the first connection 20 and the second connection portion 30. The first outer threaded portion 21 and the second outer threaded portion 31 are partially embraced by the core portion 40. The flanges 22 are embraced by the core portion 40. The first outer threaded portion 21, the flanges 22 and the second outer threaded portion 31 provide enough contact area for the core portion 40 so that the connection is firm.

Further referring to FIGS. 3 and 5, an outer layer 50 made of carbon-fiber is coated to the first connection portion 20, the second connection portion 30 and the core portion 40. The outer layer 50 is smooth at its outer surface so that there will be less stress concentration. Because the bicycle crank employs a lot of carbon-fiber material or other light compound material so that the total weight of the bicycle crank 10 is light.

While we have shown and described the embodiment in accordance with the present invention, it should be clear to those skilled in the art that further embodiments may be made without departing from the scope of the present invention.

What is claimed is:

1. A bicycle crank comprising:
a first connection portion having a first outer threaded portion;
a second connection portion having a second outer threaded portion;
a core portion made of carbon-fiber connected between the first connection and the second connection portion, the first outer threaded portion and the second outer threaded portion being partially embraced by the core portion, and
an outer layer made of carbon-fiber being coated to the first connection portion, the second connection portion and the core portion.

2. The bicycle crank as claimed in claim 1, wherein the first connection portion has flanges extending radially from an outer periphery thereof and the flanges are embraced by the core portion.
